(19) United States
(12) Patent Application Publication
(10) Pub. No.: US 2005/0237923 A1
(43) Pub. Date: Oct. 27, 2005

(54) Multi-bank OFDM high data rate extensions

(75) Inventors: Jaiganesh Balakrishnan, Bangalore (IN); Anuj Batra, Dallas, TX (US); Anand Dabak, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/115,816

(22) Filed: Apr. 26, 2005

Related U.S. Application Data
(60) Provisional application No. 60/565,570, filed on Apr. 26, 2004.

(51) Int. Cl. H04J 11/00; H04J 1/00

(52) U.S. Cl. 370/208; 370/343; 370/480

(57) ABSTRACT

A transmitter 200 is provided. The transmitter 200 comprises a mapper 207 operable to map a bit stream into a plurality of tones to promote high data rate multi-band orthogonal frequency division multiplex communication, wherein the tones can take on sixteen or more different values 300. In another embodiment a communications system 1360 is provided that includes a transceiver 1362 that has two or more antennas 1394 and 1396. The transceiver 1362 transmits a first multi-band orthogonal frequency division multiplex signal in multiple input/multiple output mode and receives a second multi-band orthogonal frequency division multiplex signal in multiple input/multiple output mode. In another embodiment, a transceiver 200, 202 transmits a first multi-band orthogonal frequency division multiplex symbol concurrently on a plurality of sub-bands and receives a second multi-band orthogonal frequency division multiplex symbol concurrently on a plurality of sub-bands.

### CROSS-REFERENCE TO RELATED APPLICATIONS

This application claims priority to U.S. Provisional Application No. 60/565,570 filed Apr. 26, 2004, and entitled “Multi-band OFDM high data rate extensions,” by Jaiganesh Balakrishnan, et al, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communications, and more particularly, but not by way of limitation, to a system and method for Multi-band OFDM High Data Rate extensions.

### BACKGROUND OF THE INVENTION

A network provides for communication among members of the network. Wireless networks allow connectionless communications. Wireless local area networks are generally tailored for use by computers and may employ sophisticated protocols to promote communications. Wireless personal area networks with ranges of about 10 meters are poised for growth, and increasing engineering development effort is committed to developing protocols supporting wireless personal area networks.

With limited range, wireless personal area networks may have fewer members and require less power than wireless local area networks. The IEEE (Institute of Electrical and Electronics Engineers) is developing the IEEE 802.15.3a wireless personal area network standard. The term piconet refers to a wireless personal area network having an ad hoc topology comprising communicating devices. The piconet may be coordinated by a piconet coordinator (PNC) or through some other distributed mechanism. Piconets may form, reform, and abate spontaneously as various wireless devices enter and leave each other's proximity. Piconets may be characterized by their limited temporal and spatial extent. Physically adjacent wireless devices may group themselves into multiple piconets running simultaneously.

One proposal to the IEEE 802.15.3a task group divides the 7.5 GHz ultra wide band (UWB) bandwidth from 3.1 GHz to 10.6 GHz into fourteen sub-bands, where each sub-band is 528 MHz wide. These fourteen sub-bands are organized into four band groups each having three 528 MHz sub-bands and one band group of two 528 MHz sub-bands. An example piconet may transmit a first multi-band orthogonal frequency division multiplex (MB-OFDM) symbol in a first 312.5 nS duration time interval in a first frequency sub-band of a band group, a second MB-OFDM symbol in a second 312.5 nS duration time interval in a second frequency sub-band of the band group, and a third MB-OFDM symbol in a third 312.5 nS duration time interval in a third frequency sub-band of the band group. Other piconets may also transmit concurrently using the same band group, discriminating themselves by using different time-frequency codes and a distinguishing preamble sequence. This method of piconets sharing a band group by transmitting on each of the three 528 MHz wide frequencies of the band group may be referred to as time frequency coding or time frequency interleaving (TFI). Alternately, piconets may transmit exclusively on one sub-band of the band group which may be referred to as fixed frequency interleaving (FFI). Piconets employing fixed frequency interleaving may distinguish themselves from other piconets employing time frequency interleaving by using a distinguishing preamble sequence. In practice four distinct preamble sequences may be allocated for time frequency interleaving identification purposes and three distinct preamble sequences may be allocated for fixed frequency interleaving. In different piconets different time-frequency codes may be used. In addition, different piconets may use different preamble sequences.

The structure of a message packet according to the Multi-band OFDM Alliance SIG physical layer specification, the WiMedia wireless personal area network protocol, and the Ecma wireless personal area network protocol comprises a preamble field, a header field, and a payload field. The preamble field may contain multiple instances of the distinct preamble sequence. The preamble field may be subdivided into a packet and frame detection sequence and a channel estimation sequence. The channel estimation sequence is a known sequence that may be used by a receiver to estimate the characteristics of the wireless communication channel to effectively compensate for adverse channel conditions. The preamble field, the header field, and the payload field may each be subdivided into a plurality of OFDM symbols.

### SUMMARY OF THE INVENTION

A transmitter is provided. The transmitter comprises a mapper operable to map a bit stream into a plurality of tones to promote high data rate multi-band orthogonal frequency division multiplex communication, wherein the tones contain a data and the data can take on sixteen or more different values.

A communication system is provided. The communication system comprises a transceiver having two or more antennas, the transceiver operable to transmit a first multi-band orthogonal frequency division multiplex signal in multiple input/multiple output mode and to receive a second multi-band orthogonal frequency division multiplex signal in multiple input/multiple output mode.

A communication system is provided. The communication system comprises a transceiver operable to transmit a first multi-band orthogonal frequency division multiplex message concurrently on a plurality of sub-bands, a different portion of the first message on each sub-band, and to receive a second multi-band orthogonal frequency division multiplex signal concurrently on a plurality of sub-bands, a different portion of the second message on each sub-band.

A communication system is provided. The communication system comprises a transceiver having two or more antennas, the transceiver operable in a first mode to transmit a first multi-band orthogonal frequency division multiplex signal in multiple input/multiple output mode and to receive a second multi-band orthogonal frequency division multiplex signal in multiple input/multiple output mode, the transceiver operable in a second mode to transmit concurrently a third multi-band orthogonal frequency division multiplex signal with a first antenna on a first sub-band and to transmit a fourth multi-band orthogonal frequency division multiplex signal with a second antenna on a second sub-band and to receive concurrently a fifth multi-band orthogonal frequency division multiplex signal with the first antenna on a third sub-band and to receive a sixth multi-band orthogonal frequency division multiplex signal with the second antenna on a fourth sub-band.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 depicts an exemplary wireless piconet for implementing an embodiment of the disclosure.

FIG. 2 is a block diagram of a transmitter in communication with a receiver according to an embodiment of the disclosure.

FIG. 3 is an illustration of a sixteen quadrature amplitude modulation constellation according to an embodiment of the disclosure.

FIG. 4 is a block diagram of a multiple input multiple output transmitter and receiver according to an embodiment of the disclosure.

FIG. 5 is an illustration of several bonded bands according to an embodiment of the disclosure.

FIG. 6 is an exemplary general purpose computer system having a radio transceiver card suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

The current Multi-band orthogonal frequency division multiplex (OFDM) Alliance (MBOA) Special Interest Group (SIG) Physical layer specification defines data rates from 53.3 Mbps up to 480 Mbps and restricts constellation sizes to quadrature phase shift keying (QPSK). In the future, however, users may desire higher data rates. The present disclosure provides three different strategies for providing data rates higher than 480 Mbps. One embodiment provides data rates by using a sixteen value quadrature amplitude modulation (QAM) technique to pack more information into a single OFDM tone. Another embodiment provides higher data rates by employing multiple input/output antennas in the transmit and receive chains, thereby exploiting the diversity in the communication channel. An additional embodiment provides higher data rates by combining portions of spectrum, termed channel bonding.

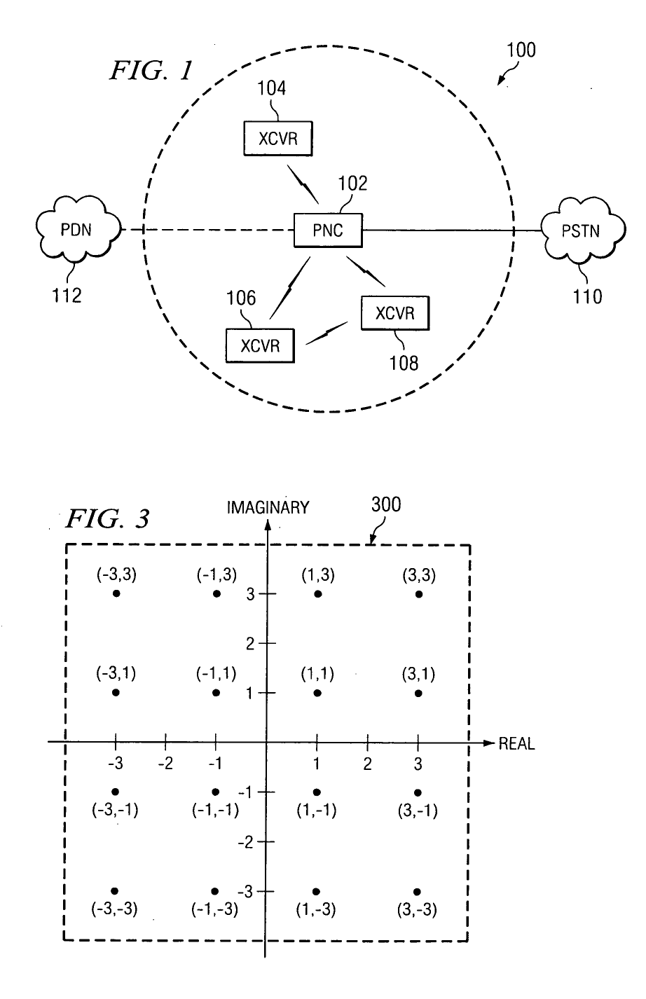

Turning now to FIG. 1, a block diagram depicts a piconet 100 formed by a number of cooperating electronic devices. A first transceiver 102 operates as the piconet controller for the piconet 100. A second transceiver 104, a third transceiver 106, and a fourth transceiver 108 operate as member of the piconet 100. The transceivers 102, 104, 106, and/or 108 may also be capable of operating as the piconet controller of the piconet 100, but are not depicted as carrying out that role. The first transceiver 102 may broadcast beacon messages, which may be referred to simply as beacons, to promote communication among the members of the piconet 100. The effective range of the beacon messages, and hence the effective boundary of the piconet 100, is depicted by a dashed line in FIG. 1. The first transceiver 102 may be connected to either a public switched telephone network 110 or to a public switched data network 112 whereby the members of the piconet 100, for example the transceivers 102, 104, 106, and 108, may communicate with the Internet or other network of interconnected communication devices. The transceivers 102, 104, 106, and 108 may wirelessly communicate according to the MBOA SIG Physical layer specification. The wireless communications within the piconet 100 are transmitted and received as a sequence of orthogonal frequency division multiplex (OFDM) symbols. The transceivers 102, 104, 106, and 108 may be operable for implementing the present disclosure.

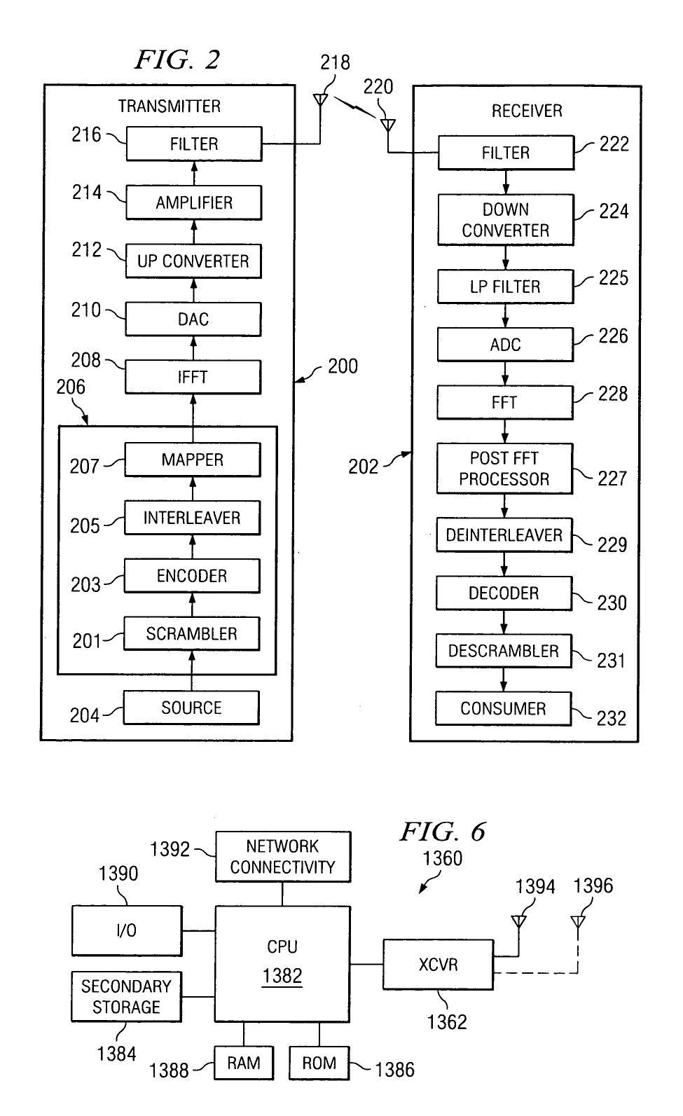

Turning now to FIG. 2, a wireless transmitter 200 is shown in communication with a wireless receiver 202. Some conventional elements of transmitters and receivers may be omitted from FIG. 2 but will be readily apparent to one skilled in the art. The wireless transmitter 200 is suitable for transmitting OFDM symbols formatted according to embodiments of the present disclosure, and the wireless receiver 202 is suitable for receiving the OFDM symbols formatted according to embodiments of the present disclosure. A signal source 204 provides data to be transmitted to a modulator 206. The modulator 206 may comprise a spreader or scrambler component 201, a block encoder 203, an interleaver 205, and a mapper 207. The scrambler component 201 processes the data, which may be referred to as a bit stream or information bits, and provides input information data to the encoder 203. The encoder 203 encodes the input information data. In an embodiment, the encoder 203 may add redundancy to the information bits to promote the ability of the wireless receiver 202 to decode the information bits, for example using a convolutional coding algorithm. As a result of the processing by the encoder 203, an input information bit may be spread into many different coded bits. An interleaver 205 may further process the bit stream. In an embodiment, a six-symbol interleaver may be employed, and as a result of the processing in interleaver 205 a first information bit may be located in a first symbol, the second information bit may be located in a third symbol, the third information bit may be located in a sixth symbol, and other subsequence information bits may be similarly displaced from their initial ordered position in the bit stream. The output of the interleaver 205 is provided to a mapper 207 that maps the output of the interleaver onto quadrature amplitude modulation (QAM) constellations for each of the tones. The modulator 206 provides the tones to an inverse fast Fourier transformer component 208 which translates the frequency domain representation of the data into a time domain representation of the same data.

The inverse fast Fourier transformer component 208 provides the time domain representation of the signal to a digital-to-analog converter 210 which converts the digital representation of the signal to an analog form. The analog form of the signal is a 528 MHz wide baseband signal. The digital-to-analog converter (DAC) 210 provides the 528 MHz wide baseband signal to an up converter 212 which frequency shifts the 528 MHz wide baseband signal to the appropriate frequency band for transmission. The up converter 212 provides the up converted 528 MHz wide signal to an amplifier 214 which boosts the signal strength for wireless transmission. The amplifier 214 feeds the up converted, amplified, 528 MHz wide signal to a band-select filter 216, typically having a bandwidth of 1584 MHz, that attenuates any spurious frequency content of the up converted signal which lies outside the desirable three bands of the MB-OFDM signal. The band-select filter 216 feeds a transmitting antenna 218 which wirelessly transmits the up converted, amplified, band-select filtered 528 MHz wide signal. In some embodiments, the band-select filter 216 may be omitted or bypassed.

The wireless signal is received by a receiving antenna 220. The receiving antenna 220 feeds the signal to a receiving band-select filter 222, typically having a bandwidth of 1584 MHz, that selects all three bands of the MB-OFDM signal from the entire bandwidth which the receiving antenna 220 is capable of receiving. The receiving band-select filter 222 feeds the selected MB-OFDM signal to a down converter 224 which frequency shifts the MB-OFDM signal to a 528 MHz baseband signal. The down converter 224 feeds the 528 MHz baseband signal to a base-band, low-pass filter 225, typically having a 528 MHz bandwidth. The base-band, low-pass filter 225 feeds the filtered 528 MHz baseband signal to an analog-to-digital converter (ADC) 226 which digitizes the filtered 528 MHz baseband signal. The analog to digital converter 226 feeds the digitized 528 MHz baseband signal to a fast Fourier transformer 228 which converts the digitized 528 MHz baseband signal from the time domain to the frequency domain, decomposing the digitized 528 MHz baseband signal into distinct frequency domain tones. The fast Fourier transformer 228 feeds the frequency domain tones to a post FFT processing block 227 that performs frequency domain equalization to compensate for the multi-path channel, phase tracking and correction and also the demapping. The post FFT processing block 227 output feeds to a deinterleaver 229 that reverses the processing performed in the transmitter 200 by the interleaver 205. The deinterleaver 229 output feeds to a decoder component 230 that extracts the data from the blocks. The decoder component 230 output feeds to a descrambler component 231 which reverses the processing performed in the transmitter 200 by the scrambler component 201. The stream of data is then provided to a medium access control (MAC) component 232 or higher layer application which interprets and uses the stream of data.

The wireless transmitter 200 and wireless receiver 202 structures described above may be combined in some embodiments in a single device referred to as a transceiver, for example the transceivers 102, 104, 106, and 108 described above with reference to FIG. 1. While the transmitting bandpass filter 216 and the amplifier 214 are described as separate components, in some embodiments these functions may be integrated in a single component. Additionally, in some embodiments the up converted 528 MHz bandwidth signal may be bandpass filtered by the transmitting bandpass filter 216 before it is amplified by the amplifier 214. Other systems, components, and techniques may be implemented for these purposes which will readily suggest themselves to one skilled in the art and are all within the spirit and scope of the present disclosure.

Turning now to FIG. 3, a QAM constellation 300 is depicted having sixteen distinct values, the first of the three embodiments that promote higher data rates. Each distinct value is represented by a point plotted against a real axis and an imaginary axis. The distinct values can be represented as pairs of real and imaginary number pairs as (1,1), (3,1), (1,3), (3,3), (−1,1), (−3,1), (−1,3), (−3,−3), (−1,−1), (−3,−1), (−3,−1), (−3,−3), (1,−1), (3,−1), (1,−3), and (3,−3), where the left number represents the real component of the value and the right number represents the imaginary component of the value. The QAM constellation 300 may be referred to as QAM 16, because the constellation has sixteen different values. It is readily apparent to one skilled in the art, that the values of the pairs may be proportionally scaled to achieve desired amplitudes. Additionally, other distributions of the sixteen values may be employed that promote maximum ability of a receiver to distinguish among the sixteen values. The QAM constellation 300 encodes four bits of data, thereby doubling the two bit information content of the QPSK constellation currently employed for multi-band OFDM communication. Transmissions from the transceivers 102, 104, 106, and 108 using the QAM constellation 300 may increase the data rate for multi-band OFDM communications. The mapper 207 and the post FFT processor 227 may be modified to support the QAM constellation 300. To promote performance substantially equivalent to QPSK encoding, 6.9 dB additional link margin may be employed, i.e., higher received power is generally called for to support 16 QAM as compared to QPSK. Because transmission power levels may be constrained by specifications, obtaining a higher link margin may entail operating the transceivers 102, 104, 106, and 108 in closer physical proximity to each other.

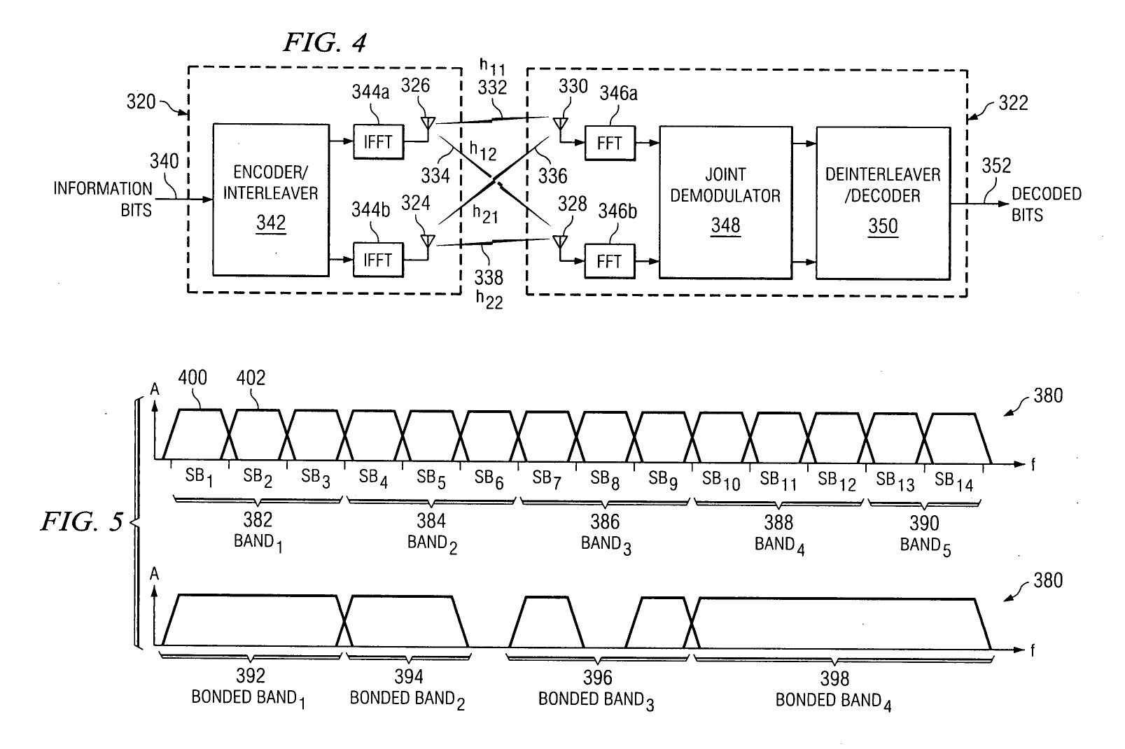

Turning now to FIG. 4, the second of the three embodiments that promote higher data rates, a transmitter 320 is shown in communication with a receiver 322 according to multi-band OFDM techniques. The transmitter 320 employs a first antenna 324 and a second antenna 326 to transmit, and the receiver 322 employs a third antenna 328 and a fourth antenna 330 to receive a multi-band OFDM wireless signal. The four communication channels between these antennas may be represented as a channel h₁₁ 332 the channel between the second antenna 326 and the fourth antenna 330, a channel h₁₂ 334 the channel between the second antenna 326 and the third antenna 328, a channel h₂₁ 336 the channel between the first antenna 324 and the fourth antenna 330, and a channel h₂₂ 338 between the first antenna 324 and the third antenna 328.

In an embodiment, the bits of an information bit stream 340 may be provided by a higher layer application and are encoded, interleaved, and divided into two parallel bit streams, which may be referred to as two precursor signals, by an encoder/interleaver component 342. In an embodiment, the two parallel bit streams may be provided by the encoder/interleaver component 342, as for example a first bit stream containing bits of every other bit of the information bit stream 340 and a second bit stream containing the remaining bits of the information bit stream 340. This may be termed spatial multiplexing mode. Alternatively, in another embodiment, a third bit stream may contain every bit of the information bit stream 340 and a fourth bit stream may contain every bit of the information bit stream 340 modified in a known way to increase the probability that the combination of the third and fourth bit streams may be correctly demodulated at the receiver 322. The transmission involving duplication of information bit stream 340 may be termed transmit diversity mode.

The two parallel bit streams are mapped onto frequency tones, such as by a mapper component substantially similar to the mapper 207 of FIG. 2, and the two parallel streams of frequency tones are transformed from frequency domain signals to time domain signals by a first inverse fast Fourier transformer (IFFT) 344a and a second IFFT 344b. The time domain signals are conditioned for transmission by other components of the transmitter 320, such as by two sets of components substantially similar to the DAC 210, the up converter 212, the amplifier 214, and the band-select filter 216 of FIG. 2. The time domain signals are then transmitted by the first antenna 324 and the second antenna 326. Note that the same portions of spectrum are employed for transmitting the two parallel bit streams, for example one of the 528 MHz sub-bands described above. The two signals transmitted by the first antenna 324 and the second antenna 326 may be referred to collectively as a multi-band OFDM signal in MIMO mode and this multi-band OFDM signal in MIMO mode may be said to be based on the two precursor signals.

Both the third antenna 328 and the fourth antenna 330 receive the two transmissions from the transmitter 320. The receiver 322 may convert the received signals, that may be referred to as a multi-band OFDM signal in MIMO mode, to base-band signals, such as by processing with two sets of components such as the receiving band-select filter 222, the down converter 224, the base-band, low-pass filter 225, and the ADC 226 of FIG. 2. A first fast Fourier transformer (FFT) 346a and a second FFT 346b transform the signals from the time domain to the frequency domain and feeds two parallel bit streams to a demodulator 348. In an embodiment, a single FFT 346 may be employed to transform both bit streams by running the FFT 346 at twice the speed appropriate for transforming a single bit stream. In an embodiment, the two parallel bit streams are jointly demodulated, such as by using a maximum ratio combining or an equal gain combining demodulation technique, for example. The two parallel bit streams, which may be referred to as two derived signals, are further processed by a deinterleaver/decoder 350 to recombine the two parallel bit streams to produce a decoded information bit stream 352 that conforms with the information bit stream 340 provided to the transmitter 320. The decoded information bit stream 352 may be provided to a higher layer application.

The transmitter 320 and the receiver 322 structures described above may be combined in some embodiments in a transceiver, for example, the transceivers 102, 104, 106, and 108. When the receiver 322 and the transmitter 320 are combined in a transceiver, a switch or a hybrid (not shown) may be used to separate output and input signals at the antenna, as is well known to one skilled in the art. The use of multiple antennas, as described above, transmitting and receiving different signals may be referred to as a multiple input/multiple output (MIMO) mode of operation. Higher data rates may be achieved in MIMO mode, relative to an equivalent non-MIMO transceiver, in either the spatial multiplexing mode or the transmit diversity mode. In an embodiment, the transmitter 320 may employ more than two antennas 324, 326 and the receiver 322 may employ more than two antennas 328, 330.

In an embodiment, the transmitter 320 may transmit a first MB-OFDM signal on a first sub-band on the first antenna 324 and transmit a second MB-OFDM signal on a second sub-band on the second antenna 326. The receiver 322 may receive a third MB-OFDM signal on a third sub-band on the third antenna 328 and receive a fourth MB-OFDM signal on a fourth sub-band on the fourth antenna 330. The first sub-band and/or the second sub-band may identical to the third sub-band or the fourth sub-band. This mode of operation may be referred to as enhanced-MIMO mode to distinguish it from normal MIMO mode. In this embodiment, the transmitter 320 and the receiver 322, as described above, may be combined in a transceiver. Additionally, the transmitter 320 and the receiver 322 may be capable of operating in both MIMO and enhanced-MIMO modes, switching from MIMO mode to enhanced-MIMO mode and from enhanced-MIMO mode to MIMO mode dynamically. The enhanced-MIMO mode may provide the opportunity to create more time-frequency codes, because in addition to time and frequency, space is also available to distinguish signals in the piconet 100. The enhanced-MIMO mode may provide, in a sense, a third dimension that promotes enhanced separation between piconets 100.

Turning now to FIG. 5, a plurality of bonded bands that combine two or more sub-bands of the multi-band OFDM spectrum 380 are depicted, the third of the three embodiments that promote higher data rates. The transceivers 102, 104, 106, and 108 may transmit and receive using bonded bands to increase data rates. The fourteen sub-bands are shown organized into five bands of the multi-band OFDM spectrum 380—a band₁ 382, a band₂ 384, a band₃ 386, a band₄ 388, and a band₅ 390. As discussed above, band₅ 390 comprises two sub-bands and the other bands 382, 384, 386, and 388, comprise three sub-bands each. Each sub-band covers a 528 MHz bandwidth. Higher data rates may be achieved by combining two or more sub-bands, obtaining greater bandwidth as integer multiples of 528 MHz.

Bonded band₁ 392 concatenates the three sub-bands of band₁ 382 to achieve an aggregate bandwidth of 1584 MHz or 1.584 GHz. Other things being equal, the bonded band₁ 392 may be expected to provide a three times increase in data rate with respect to any one of the sub-bands. Bonded band₂ 394 concatenates the first two sub-bands of band₂ 384 to achieve an aggregate bandwidth of 1056 MHz or 1.056 GHz that may be expected to provide a two times increase in data rate with respect to any one of the sub-bands. Bonded band₃ 396 combines two non-contiguous sub-bands of band₃ 386 to achieve an aggregate bandwidth of 1056 MHz or 1.056 GHz that may be expected to provide a two times increase in data rate with respect to any one of the sub-bands. Bonded band₄ concatenates five sub-bands—the three sub-bands of band₄ 388 and the two sub-bands of band₅ 390 to achieve an aggregate bandwidth of 2640 MHz or 2.640 GHz that may be expected to provide a five times increase in data rate with respect to any one of the sub-bands. Other bonded bands are contemplated by the present disclosure. Generally, a bonded band may be formed by combining any two or more sub-bands of the multi-band OFDM spectrum 380. The expected increase in data rate is the total number of sub-bands combined.

Different bonded bands may be employed by a transceiver, for example the first transceiver 102, for transmitting and receiving. For example, the first transceiver 102 may transmit on the bonded band₃ 396 and receive on the bonded band₄ 398. The transceivers, for example the first transceiver 102, may employ a different number of sub-bands for transmitting than the number of sub-bands employed for receiving.

The use of bonded bands as described above may provide additional data rate increases due to more efficient use of the boundary areas between sub-bands. For example, the encoding of the data on the tones of sub-band₁ 400 and the data on the tones of the sub-band₂ 402 that are located near each other in band₁ 382 may use reduced constellation encoding or decreased bit counts due to cross-sub-band interference. The bonded band₁ 392 would not be expected to experience cross-sub-band interference at this portion of the spectrum, may employ higher constellation encoding, and hence may realize an increased data rate due to the higher constellation encoding employed for the several tones in this area of the spectrum. In practice, however, it may be difficult to benefit from this increased efficiency because data rates may be constrained to fixed values and the increase in data rate needed to transition to the next higher allowed data rate may substantially exceed the data rate increase supported by the increased efficiency.

The three approaches to providing higher data rates in multi-band OFDM communication described above may be associated with different design challenges. For example, deploying the QAM constellation 300 described with reference to FIG. 3 above, or QAM 16, may motivate a redesign of existing multi-band OFDM radio stages to provide greater linearity and higher signal-to-noise ratios (SNR). Deploying the MIMO transmitters, receivers, and/or transceivers described above with reference to FIG. 4 may not motivate a redesign of existing multi-band OFDM radio stages but may increase the cost of these devices due to duplicated antennas and radio stages. Additionally, greater processing complexity may be involved in demodulating the MIMO signals. Deploying bonded band communications may motivate development of additional negotiation protocols to acquire the right to expropriate multiple sub-bands, for example where the second transceiver 104 negotiates with the first transceiver 102, operating in the role of piconet controller, to acquire the right to expropriate all of the sub-bands of band₁ 382 to compose and employ the bonded band₁ 392. Additionally, the existing multi-band OFDM radio stages and the base-band stages may be redesigned to provide greater operating bandwidth and to accommodate stop-bands or gaps in the bonded band, for example the bonded band₃ 396. In an embodiment, two or more of these approaches to providing higher data rates in multi-band OFDM communications may be employed by the transceivers 102, 104, 106, and 108. For example, 16 QAM may be used in association with MIMO and/or channel bonding; and MIMO can be used in association with channel bonding and/or 16 QAM.

The transceivers 102, 104, 106, and 108 described above may be implemented in various ways, including on a single integrated circuit or on a plurality of integrated circuits coupled together such as is well known to those skilled in the art. In one embodiment the transceivers 102,104, 106, and 108 are implemented as a printed circuit card.

Turning now to FIG. 6, a system 1360 illustrates an exemplary piconet member device. A transceiver card 1362 provides the functionality of the transmitter 200 and the receiver 202. The transceiver card 1362 may comprise a system-on-a-chip that combines digital and analog functions. The system-on-a-chip may further include radio frequency processing functions. The transceiver card 1362 may include one or more digital signal processors (DSPs), central processing units (CPUs), and/or application specific integrated circuits (ASICs) that implement various digital processing functions of the transceiver card 1362. The transceiver card 1362 is connected to a fifth antenna 1394 and an optional sixth antenna 1396. The fifth antenna 1394 and the optional sixth antenna 1396 are substantially similar to the first and second antennas 324, 326 described with reference to FIG. 4. The optional sixth antenna 1396 may support MIMO mode operations.

The transceiver card 1362 is coupled to a central processing unit (CPU) 1382. The CPU 1382 provides a communication packet to the transceiver card 1362 and receives communication packets from the transceiver card 1362, for example data link layer packets. The CPU 1382 may be a producer of the information bit stream 340 and/or a consumer of the decoded information bit stream 352. Higher layer applications may execute on the CPU 1382.

The CPU 1382 is in communication with memory devices including optional secondary storage 1384, read only memory (ROM) 1386, random access memory (RAM) 1388, input/output (I/O) 1390 devices, and network connectivity devices 1392. Other memory devices may also be employed, such as FLASH memory. The CPU 1382 may be implemented as one or more CPU chips.

The optional secondary storage 1384 is typically comprised of one or more disk drives or tape drives and is used for non-volatile storage of data and as an over-flow data storage device if RAM 1388 is not large enough to hold all working data. The optional secondary storage 1384 may be used to store programs which are loaded into RAM 1388 when such programs are selected for execution. The ROM 1386 is used to store instructions and perhaps data which are read during program execution. ROM 1386 is a non-volatile memory device which typically has a small memory capacity relative to the larger memory capacity of secondary storage. The RAM 1388 is used to store volatile data and perhaps to store instructions. Access to both ROM 1386 and RAM 1388 is typically faster than to secondary storage 1384.

I/O 1390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 1392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as Global System for Mobile Communications (GSM) radio transceiver cards, and other well-known network devices. These network connectivity 1392 devices may enable the processor 1382 to communicate with an Internet or one or more intranets. With such a network connection, it is contemplated that the CPU 1382 might receive information from the network, or might output information to the network in the course of performing the above-described method steps. Such information, which is often represented as a sequence of instructions to be executed using the CPU 1382, may be received from and outputted to the network, for example, in the form of a computer data signal embodied in a carrier wave

Such information, which may include data or instructions to be executed using the CPU 1382 for example, may be received from and outputted to the network, for example, in the form of a computer data baseband signal or signal embodied in a carrier wave. The baseband signal or signal embodied in the carrier wave generated by the network connectivity 1392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The CPU 1382 executes instructions, codes, computer programs, scripts which it accesses from hard disk, floppy disk, optical disk (these various disk based systems may all be considered to be optional secondary storage 1384), ROM 1386, RAM 1388, or the network connectivity devices 1392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A transmitter, comprising:
a mapper operable to map a bit stream into a plurality of tones to promote high data rate multi-band orthogonal frequency division multiplex communication, wherein the tones contain a data and the data can take on sixteen or more different values.

2. The transmitter of claim 1, wherein the data on the tones are quadrature amplitude modulation symbols.

3. The transmitter of claim 1, further including a receiver operable to receive a multi-band orthogonal frequency division multiplex communication.

4. The transmitter of claim 1, wherein the data comprises a plurality of information bits, the information bits spread across one of a plurality sub-bands and a plurality of symbols, and the information bits are loaded into different portions of the data on the tones.

5. The transmitter of claim 1, wherein the data comprises a plurality of information bits and further including:
an encoder operable to introduce redundancy into the information bits; and
an interleaver operable to interleave the information bits and to provide the information bits to the mapper, the information bits spread across one of a plurality of sub-bands and symbols and loaded into different portions of the data on the tones.

6. A communication system, comprising:
a transceiver having two or more antennas, the transceiver operable to transmit a first multi-band orthogonal frequency division multiplex signal in multiple input/multiple output mode and to receive a second multi-band orthogonal frequency division multiplex signal in multiple input/multiple output mode.

7. The communication system of claim 6, wherein the transceiver includes a mapper operable to map a bit stream into a plurality of tones, wherein the tones contain a data that can take on sixteen or more different values and the first multi-band orthogonal frequency division multiplex signal in multiple input/multiple output mode is based at least in part on the tones.

8. The communication system of claim 7, wherein the transceiver is further operable to transmit the first multi-band orthogonal frequency division multiplex signal in multiple input/multiple output mode concurrently on a plurality of sub-bands and to receive the second multi-band orthogonal frequency division multiplex signal in multiple input/multiple output mode concurrently on a plurality of sub-bands.

9. The communication system of claim 6, wherein the transceiver is further operable to transmit the first multi-band orthogonal frequency division multiplex signal in multiple input/multiple output mode concurrently on a plurality of sub-bands and to receive the second multi-band orthogonal frequency division multiplex signal in multiple input/multiple output mode concurrently on a plurality of sub-bands.

10. The communication system of claim 6, wherein the transceiver is operable to jointly demodulate the second multi-band orthogonal frequency division multiplex signal in multiple input/multiple output mode.

11. The communication system of claim 6, wherein the transceiver includes a transmitter having a first inverse fast Fourier transformer, a second inverse fast Fourier transformer, and two time domain output processing components and a receiver having a first fast Fourier transformer, a second fast Fourier transformer, and two time domain input processing components.

12. The communication system of claim 11, wherein the transceiver further includes an encoder and interleaver component operable to provide a first precursor signal to the first inverse fast Fourier transformer and a second precursor signal to the second inverse fast Fourier transformer, where the first multi-band orthogonal frequency division multiplex signal is based on the first and second precursor signals.

13. The communication system of claim 11, wherein the receiver further includes a decoder and deinterleaver component operable to process a first derived signal received from the first fast Fourier transformer and a second derived signal received from the second fast Fourier transformer, where the first derived signal and the second derived signal are based on the second multi-band orthogonal frequency division multiplex signal.

14. The communication system of claim 6, wherein transceiver transmits the first signal in spatial diversity mode.

15. The communication system of claim 6, wherein the transceiver transmits the first signal in transmit diversity mode.

16. The communication system of claim 6, wherein the transceiver receives the second signal in transmit diversity mode and demodulates the second signal using a demodulation method selected from the group consisting of a maximum ratio combining demodulation technique and an equal gain combining demodulation technique.

17. A communication system, comprising:
a transceiver operable to transmit a first multi-band orthogonal frequency division multiplex symbol concurrently on a plurality of sub-bands and to receive a second multi-band orthogonal frequency division multiplex symbol concurrently on a plurality of sub-bands.

18. The communication system of claim 17, wherein the transceiver is operable to transmit the first symbol concurrently on three sub-bands and to receive the second symbol concurrently on three sub-bands.

19. The communication system of claim 17, wherein at least one of the sub-bands is non-contiguous with at least some of the remaining sub-bands.

20. The communication system of claim 17, wherein the transceiver is further operable to negotiate to obtain the right to transmit on the plurality of sub-bands

21. The communication system of claim 17, wherein the plurality of sub-bands on which the transceiver transmits is different from the plurality of sub-bands on which the transceiver receives.

22. The communication system of claim 17, wherein the number of sub-bands on which the transceiver transmits is different from the number of sub-bands on which the transceiver receives.

23. The communication system of claim 17, wherein the sub-bands belong to two or more bands.

24. The communication system of claim 16, wherein the transceiver includes a mapper operable to map a bit stream into a plurality of tones, wherein the tones contain a data that can take on sixteen or more different values and the first symbol is based at least in part on the tones.

25. A communication system, comprising:
a transceiver having two or more antennas, the transceiver operable in a first mode to transmit a first multi-band orthogonal frequency division multiplex signal in multiple input/multiple output mode and to receive a second multi-band orthogonal frequency division multiplex signal in multiple input/multiple output mode, the transceiver operable in a second mode to transmit concurrently a third multi-band orthogonal frequency division multiplex signal with a first antenna on a first sub-band and to transmit a fourth multi-band orthogonal frequency division multiplex signal with a second antenna on a second sub-band and to receive concurrently a fifth multi-band orthogonal frequency division multiplex signal with the first antenna on a third sub-band and to receive a sixth multi-band orthogonal frequency division multiplex signal with the second antenna on a fourth sub-band.

26. The communication system of claim 25, wherein the first sub-band and second sub-band are the same.

27. The communication system of claim 25, wherein the first sub-band and second sub-band are different.
